(19) United States
(12) Patent Application Publication
(10) Pub. No.: US 2018/0325128 A1
(43) Pub. Date: Nov. 15, 2018

(54) COLLAGEN CASINGS WITH ADDED CHITOSAN

(71) Applicant: Nitta Casings Inc., Bridgewater, NJ (US)

(72) Inventors: Eugene Goldfarb, Marlboro, NJ (US); Masayuki Mimasu, Bound Brook, NJ (US); David Mathews, Somerville, NJ (US)

(21) Appl. No.: 15/973,695

(22) Filed: May 8, 2018

Related U.S. Application Data
(60) Provisional application No. 62/503,624, filed on May 9, 2017.

(51) Int. Cl. A22C 13/00

(52) U.S. Cl. CPC A22C 13/0016

(57) ABSTRACT

Collagen casings comprising chitosan as an anti-microbial agent are provided. The collagen casings may be produced by adding chitosan during the gelling of quarter grind hides, by injecting chitosan into collagen gel prior to extrusion, or by applying a chitosan solution to a surface of extruded collagen casings.

This application claims priority under 35 U.S.C. § 119(e) to U.S. Provisional Patent Application No. 62/503,624 titled “Collagen Casings with Added Chitosan” filed on May 9, 2017, the entire contents of which are hereby incorporated by reference.

### BACKGROUND OF THE INVENTION

Reconstituted collagen is used in the manufacture of tubular casings for meats, such as sausages. The collagen used in these casings is usually derived from the corium layer of bovine hides. The collagen raw material is comminuted, and mixed with a swelling agent to produce a uniform dispersion from which a continuous tube is formed. The tube is then neutralized by the injection of gaseous ammonia or by contact with a liquid salt solution. The casing is washed in water to remove neutralization salts, plasticized by passing it through successive liquid baths and dried while inflated. Examples of such processes are disclosed in U.S. Pat. Nos. 3,535,125, 3,821,439, 4,388,331, and 5,820,812, the entire contents of each of which are hereby incorporated by reference

Anti-microbial additives are sometimes used in collagen casings to extend the shelf life of the collagen casing and the product contained within the casing. Typical anti-microbial additives used in collagen casings may include sodium benzoate, potassium sorbate, citric acid, lactic acid, benzoic acid, sorbic acid, sodium lactate, potassium lactate and sodium chlorite. It would be desirable to have a collagen casing having a natural anti-microbial additive to extend the shelf life of products using a collagen casing.

Chitosan is produced by deacetylation of chitin, which is the structural element in the exoskeleton of crustaceans such as crabs and shrimp. Chitosan is a natural product, is hypoallergenic and has natural antibacterial properties. It would be desirable to have a collagen casing having a natural anti-microbial product such as chitosan.

### SUMMARY OF THE INVENTION

An edible collagen tubular casing is produced having added chitosan. The antibacterial properties of chitosan can extend the shelf life of the collagen casing and the products contained within the casing. In some embodiments, the edible collagen casing comprises between about 0.15 wt % to about 3.0 wt % chitosan (dry basis). In one embodiment, the edible collagen casing comprises between about 0.25 wt % to about 3.0 wt % chitosan (dry basis). In another embodiment, the edible collagen casing may comprise between about 0.75% wt % to about 1.0 wt % chitosan (dry basis). In yet another embodiment, the edible collagen casing may comprise between about 0.15% wt % to about 0.85 wt % chitosan (dry basis). The invention is not limited in this regard, and the collagen casing may contain any desired amount of chitosan to provide anti-microbial protection for the collagen casing.

The tubular collagen casing may be produced by treating the corium layer of bovine hides to produce ground corium collagen hide solids. The ground corium collagen hide solids are mixed with an aqueous solution of cellulose and hydrochloric acid to produce a collagen gel. The collagen gel is filtered and extruded to produce a tubular collagen casing, which is dried and reeled.

Chitosan may be added during one or more of the processing steps described above for producing the collagen casing. In one embodiment, the chitosan may be added during the step of gelling the ground collagen by combining the chitosan with the hydrochloric acid and cellulose solution used in the gelling process. The chitosan may be combined with the hydrochloric acid and cellulose in a blending tank, and the mixture is blended with the ground corium collagen to produce a gelled collagen product containing chitosan for processing into casings. In one embodiment, the solution in the blending tank contains between about 0.02 wt % to about 0.32 wt % chitosan.

In another embodiment, the chitosan is added to the gelled collagen product prior to extrusion of the collagen into the tubular casing. A solution containing chitosan is injected into the collagen gel before, during or after filtering of the collagen gel and prior to extrusion of the gel into a tubular casing. In one embodiment, the solution injected into the collagen gel comprises between about 0.02 wt % to 0.30 wt % chitosan.

In one embodiment, the concentration of chitosan in the gel is between about 0.008% to about 0.123% (wet basis).

In yet another embodiment, the chitosan is applied to the collagen casing after the extruded collagen has been dried and before reeling. In this embodiment, a chitosan solution is applied to the surface of the collagen casing using an applicator. The chitosan solution may be applied to the surface of the collagen casing, or may be applied by injection through the shirring mandrel. In one embodiment, the solution applied to the collagen casing comprises between about 0.25 wt % to 3.0 wt % chitosan.

Among the advantages of the process are that the collagen casings include an additive with antimicrobial properties that can extend the shelf life of the casing and products contained within the casing. Other advantages of the process and products of the present invention will be apparent to one skilled in the art based upon the Description of Embodiments of the Invention set forth below.

### BRIEF DESCRIPTION OF THE DRAWINGS

FIG. 1 is a schematic showing embodiments of the process wherein collagen casings having added chitosan are produced.

### DESCRIPTION OF EMBODIMENTS OF THE INVENTION

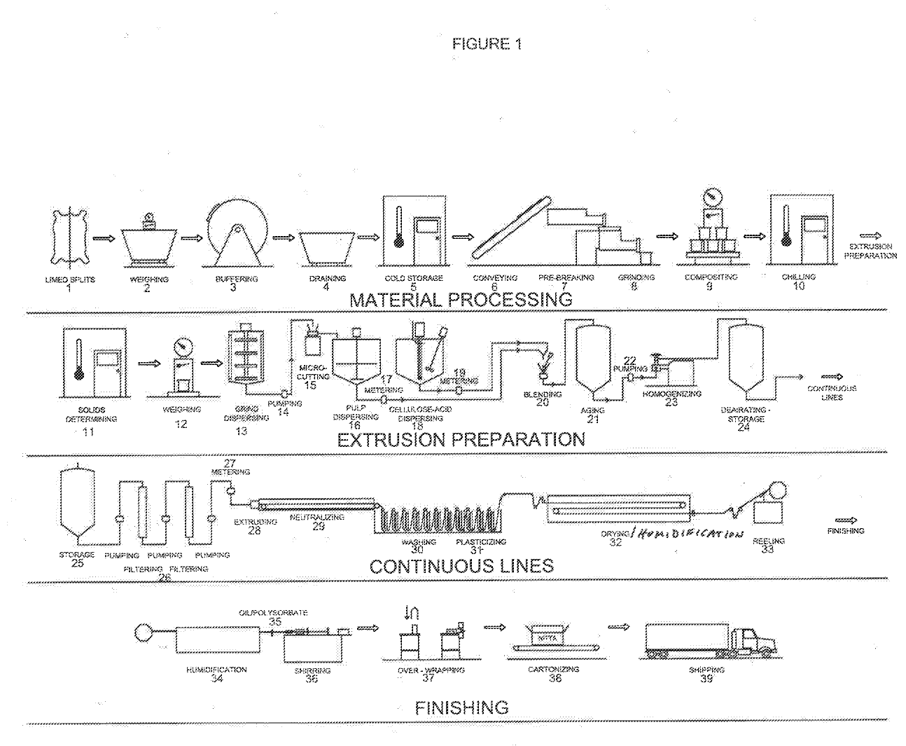

Conventional processes for producing edible collagen casings are known and have been described, for example, in U.S. Pat. No. 5,820,812, the entire contents of which are hereby incorporated by reference. The steps and equipment used in embodiments of the process to produce a collagen casing with added chitosan is shown schematically in FIG. 1. The invention is not limited in this regard, and collagen casing made by any process can be treated as described herein to produce a collagen casing having a desired chitosan content.

The collagen casing of the present invention includes chitosan. The collagen casing may contain any desired amount of chitosan. In some embodiments, the edible collagen casing comprises between about 0.15 wt % to about 3.0 wt % chitosan (dry basis). In one embodiment, the edible collagen casing comprises between about 0.25 wt % to about 3.0 wt % chitosan (dry basis). In another embodiment, the edible collagen casing may comprise between about 0.75% wt % to about 1.0 wt % chitosan (dry basis). In yet another embodiment, the edible collagen casing may comprise between about 0.15% wt % to about 0.85 wt % chitosan (dry basis). The invention is not limited in this regard, and the collagen casing may contain any desired amount of chitosan to provide anti-microbial protection for the collagen casing.

The collagen casing may be produced by adding chitosan at one or more points in the process for producing the collagen casing. In one process for producing the collagen casings, animal hides from freshly slaughtered animals are de-fleshed, washed with water, and treated with lime to remove hair. The lime treated animal hides are split on a leather splitting machine to separate the grain layer from the corium layer, which is used to produce the collagen casings. “Hides” is used in the description below to refer to the corium collagen layer of an animal hide that is used to produce the collagen casings. Referring to FIG. 1, the limed hides 1 may be stored in a refrigerated storeroom that is maintained at 0-4° C. until further processing as described below.

The hides are first processed to prepare the hide material for extrusion into casings. The hides are weighed 2 and treated in a buffering drum 3, which in one embodiment is capable of handling up to 3000 kg of product. In the buffering drum, the hides are first treated with an ammonium sulfate solution at a concentration in the range of about 0.5%-2.2% (w/w), then water washed. The hides are then further treated in the buffering drum with a citric acid/sodium citrate solution having a concentration of about 0.0725-0.29% (w/w), followed by another water wash. The buffering process brings the pH of the corium layer down to approximately 4.3 to 4.9. Assays are run to ensure the product reaches the appropriate pH. The buffered hides are drained 4 and the buffered hides are placed in cold storage 5 until needed for further processing.

When additional material is needed for processing, the hides are sent on a conveyor 6 to be shredded 7 and ground 8 into a quarter grind (i.e., a material having a particle size of about one-quarter inch) at less than approximately 25° C. The quarter grind material is composited 9 and chilled 10 and maintained at a temperature of about 18° C.

The chilled quarter grind material is transferred to the extrusion preparation line. The solids are measured 11 and weighed 12 and the quarter grind particles are dispersed in water 13. The dispersed quarter grind is pumped 14 to a high speed cutting mill 15 where the hide particles are further shredded to form a hydrated mass. The hydrated mass is kept mixed in a pulp dispersion tank 16. In a separate blending tank 18, a dispersion of cellulose, HCl and water at 0-10° C. is prepared. In one embodiment, the dispersion is prepared at 5° C.

In one embodiment, chitosan is added to the dispersion of HCl and cellulose in the blending tank 18 to be blended into the quarter grind. The concentration of chitosan in the blending tank is determined to achieve the desired relative amounts of chitosan, hide solids, cellulose and hydrochloric acid in the final gel product described below.

A quantity of the hydrated quarter grind particles from the pulp dispersion tank 16 is metered 17 into a blender 20. At the same time, a quantity of the cellulose-hydrochloric acid-chitosan dispersion from blending tank 18 is metered 19 into the blender 20 and blended with the hydrated quarter grind particles to form a gel product. After an initial blend period of about 15-60 minutes, the gel product is stored in an aging tank 21 for about 20 hours under vacuum. The temperature of the storage tank is maintained at less than 20° C. The gel product is then pumped 22 to a homogenizer 23 and sent to a tank 24 where it is deaerated under vacuum. The gel product so obtained has the following approximate composition:

| Ingredient | Weight Percent |
|---|---|
| Hide Solids | 4.2 to 5.3 |
| Cellulose | 0.90 to 1.70 |
| Hydrochloric Acid | 0.20 to 0.24 |
| Chitosan | 0.02 to 0.32 |
| Water | Balance |

The gel product is maintained in storage tank 25 at about 25° C. The gel product is pumped from the storage tank through a series of filters 26, which may be any appropriate type of filter. Automatic self cleaning filters may be used. In one embodiment, chitosan is injected into the gel product before, during or after the filtering step and prior to extrusion of the casing into the final product. The chitosan is injected in an aqueous solution having a chitosan concentration sufficient to achieve the desired chitosan concentration in the extruded collagen casing. In one embodiment, the concentration of chitosan in the solution injected into the gel is between about 0.02 wt % to about 0.30 wt %. In one embodiment, the concentration of chitosan in the gel is between about 0.008% to about 0.123% (wet basis). It should be understood that these concentrations are exemplary only, and the injected solution and the finished casing may contain any desired amount of chitosan.

The filtered gel product is metered 27 to the extruder 28 to form the collagen casing. The extruder is preferably a disk extruder. At the extruder, the gel is extruded to a thickness from 0.075 to 1.2 thousands of an inch, formed, and inflated pneumatically to the desired diameter, typically about 13-34 mm. The collagen casing is treated with anhydrous ammonia in the neutralizing section 29. The ammonia reacts with and neutralizes the HCl in the product and causes coagulation of the collagen. The neutralized collagen casing is washed in a fresh water bath 30 to remove ammonia salts. The washed collagen casing then travels through a series of baskets 31 containing a plasticizer. In one embodiment, the plasticizer solution is an aqueous solution containing about 2% to 6% glycerin, about 0.20% to 1.6% sodium carboxymethylcellulose or sodium alginate, and about 0 to 20 ppm sodium hypochlorite. This process dehydrates the casing for drying purposes and allows introduction of glycerin for elasticity purposes.

The collagen casing travels through a dryer 32. The moisture content of the collagen casing after drying is typically in the range of about 3% to about 5%. After drying, the collagen casing may be fed through a humidification chamber (not shown) at approximately 85% relative humidity prior to being collapsed and wound on a reel 33.

In another embodiment, a collagen casing is produced using a process similar to the process described above, with the drying process modified to produce a collagen casing having the desired final moisture content. The drying process is controlled to provide a collagen casing having a final moisture content of between about 18.5% to about 21.5% by weight. In one embodiment, the final moisture content is about 19.5% by weight. As shown in FIG. 1, in the process of the present invention, collagen casing produced in the manner described above is dried in dryer and humidity chamber 32 by feeding the casing through three zones. In the first zone, the temperature within the dryer and humidity chamber is maintained at between about 150° F. and about 195° F. In the second zone, the temperature within the dryer and humidity chamber is maintained at between about 160° F. to about 205° F. In the third zone, the temperature is maintained at between about 130° F. to about 150° F. The collagen casing is within each of the three zones for about 30 to 60 seconds.

In one embodiment of the process, the temperature within the first zone of the dryer and humidity chamber is about 190° F., the temperature within the second zone of the dryer and humidity chamber is about 200° F., and the temperature within the third zone is about 140° F. In this embodiment, the relative humidity in each zone is maintained at about 85% to about 95%.

In another embodiment of the present invention, a chitosan solution is applied to the surface of the collagen casing after drying and humidification and prior to reeling. The chitosan solution applied to the surface of the collagen casing may have a concentration of between about 0.25 wt % to about 3.0 wt %. The chitosan solution may be applied to the surface of the casing using any method and equipment known to those skilled in the art. In one embodiment, the chitosan solution is applied to the surface of the casing using the device described in U.S. Application Publication No. 2016/0302433, the entire contents of which are hereby incorporated by reference. After the chitosan solution is applied to the casing, the collagen casing is then reeled 33 and shipped for finishing.

As will be recognized by those of ordinary skill in the pertinent art based on the teachings herein, numerous changes and modifications may be made to the above-described and other embodiments of the invention without departing from its scope. For example, chitosan may be added to the blending tank with the HCl and cellulose, injected prior to extrusion and applied to the collagen casing prior to reeling, or in any combination of these steps in the process. Accordingly, this detailed description of preferred embodiments is to be taken in an illustrative as opposed to a limiting sense.

We claim:

1. A tubular collagen casing comprising collagen and chitosan.

2. The tubular collagen casing of claim 1, wherein the casing comprises between about 0.15 wt % to about 3.0 wt % chitosan (dry basis).

3. The tubular collagen casing of claim 2, wherein the casing comprises between about 0.75 wt % to about 2.0 wt % chitosan (dry basis).

4. The tubular collagen casing of claim 2, wherein the casing comprises between about 0.15 wt % to about 0.85 wt % chitosan (dry basis).

5. A process for producing a collagen casing comprising chitosan, the process comprising the steps of:
(a) providing a quantity of ground corium collagen hide solids;
(b) mixing the ground corium collagen hide solids with an aqueous solution of cellulose, hydrochloric acid and chitosan to produce a collagen gel; and
(c) extruding the collagen gel to produce a collagen casing comprising between about 0.15 wt % to about 3.0 wt % chitosan (dry basis).

6. The process of claim 5, wherein the mixture of step (b) comprises between about 4.2 wt % to about 5.3 wt % quarter grind hide solids, between about 0.90 wt % to about 1.70 wt % cellulose, between about 0.20 wt % to about 0.24 wt % hydrochloric acid, and between about 0.008 wt % to about 0.32 wt % chitosan.

7. The process of claim 6, wherein the mixture of step (b) comprises between about 0.008 wt % to about 0.123 wt % chitosan.

8. The process of claim 6, wherein the collagen casing comprises between about 0.15 wt % to about 0.85 wt % chitosan (dry basis).

9. A process for producing a collagen casing comprising chitosan, the process comprising the steps of:
(a) providing a quantity of ground corium collagen hide solids;
(b) mixing the ground corium collagen hide solids with an aqueous solution of cellulose, and hydrochloric acid to produce a collagen gel;
(c) adding chitosan to the collagen gel; and
(d) extruding the collagen gel to produce a collagen casing comprising between about 0.15 wt % to about 3.0 wt % chitosan (dry basis).

10. The process of claim 9, wherein the chitosan is added to the collagen gel by injecting a solution containing chitosan into the collagen gel prior to extrusion.

11. The process of claim 10, wherein the chitosan solution injected into the collagen gel contains between about 0.02 wt % and about 0.30 wt % chitosan.

12. The process of claim 6, wherein the chitosan concentration in the collagen gel is between about 0.008 wt % to about 0.123 wt % chitosan.

13. A process for producing a collagen casing having chitosan comprising the steps of:
(a) providing a quantity of extruded collagen casing; and
(b) applying a solution containing chitosan to a surface of the collagen casing.

14. The process of claim 13, wherein the chitosan solution applied to the collagen casing comprises between about 0.25 wt % to about 3.0 wt % chitosan.
